(19) United States
(12) Patent Application Publication
(10) Pub. No.: US 2008/0200334 A1
(43) Pub. Date: Aug. 21, 2008

(54) Method For Enhancing The Effectiveness Of Ethaboxam

(75) Inventors: Jordi Tormo I Blasco, Laudenbach (DE); Maria Scherer, Landau (DE); Reinhard Stierl, Freinsheim (DE); Siegfried Strathmann, Limburgerhof (DE); Matthias Niedenbruck, Limburgerhof (DE); Horst Dieter Brix, Landau (DE); Markus Gewehr, Kastellaun (DE); Christine Beck, Mannheim (DE)

Correspondence Address: HUTCHISON LAW GROUP PLLC, PO BOX 31686, RALEIGH, NC, 27612, US

(73) Assignee: BASF Aktiengesellschaft, Ludwigshafen (DE)

(21) Appl. No.: 11/791,191

(22) PCT Filed: Nov. 23, 2005
(86) PCT No.: PCT/EP2005/012528

§ 371 Date: May 17, 2007

(30) Foreign Application Priority Data
Nov. 25, 2004 (DE) 10 2004 057 070.1
Dec. 3, 2004 (DE) 10 2004 058 585.7

(51) Int. Cl. A01N 25/26; A01N 43/78; A01N 43/84; A01N 43/32; A01N 43/56; A01P 3/00

(52) U.S. Cl. 504/100; 514/371; 514/237.5; 514/434; 514/407

(57) ABSTRACT

Method for enhancing the fungicidal effectiveness of
a) ethaboxam of the formula I,

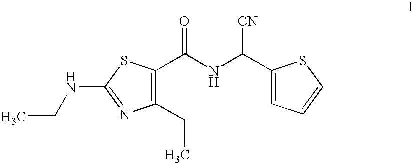

which comprises applying the active compound I simultaneously, that is separately or together, with at least one active compound II from the group consisting of:
b) dithiocarbamates, such as maneb, mancozeb, metam or metiram, sulfenic acid derivatives, such as captan or folpet, strobilurin derivatives, such as kresoxim-methyl or pyraclostrobin, cinnamides and analogs, such as dimethomorph or flumorph, or dithianon, famoxadone, cymoxanil, fluazinam, zoxamide, mefenoxam or chlorothalonil, N-(2-{4-[3-(4-chlorophenyl)prop-2-ynyloxy]-3-methoxyphenyl}ethyl)-2-methanesulfonylamino-3-methylbutyramide, N-(2-{4-[3-(4-chlorophenyl)prop-2-ynyloxy]-3-methoxyphenyl}ethyl)-2-ethanesulfonylamino-3-methylbutyramide or 5-chloro-7-(4-methylpiperidin-1-yl)-6-(2,4,6-trifluorophenyl)-[1,2,4]triazolo[1,5-a]pyrimidine
   in synergistically effective amounts, by spraying or dusting the seeds, the plants or the soils before or after sowing of the plants or before or after emergence of the plants, no polyoxyalkylene alkyl ether being used as adjuvants, novel synergistic mixtures of ethaboxam and also compositions comprising these mixtures, and the use of ethaboxam for preparing such mixtures.

The present invention relates to a method for enhancing the fungicidal effectiveness of
a) ethaboxam of the formula I,

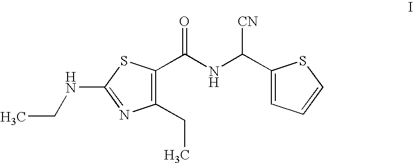

which comprises applying the active compound I simultaneously, that is separately or together, with at least one active compound II from the group consisting of:
b) dithiocarbamates, such as maneb, mancozeb, metam or metiram, sulfenic acid derivatives, such as captan or folpet, strobilurin derivatives, such as kresoxim-methyl or pyraclostrobin, cinnamides and analogs, such as dimethomorph or flumorph, or dithianon, famoxadone, cymoxanil, fluazinam, zoxamide, mefenoxam or chlorothalonil, N-(2-{4-[3-(4-chlorophenyl)prop-2-ynyloxy]-3-methoxyphenyl}ethyl)-2-methanesulfonylamino-3-methylbutyramide, N-(2-{4-[3-(4-chlorophenyl)prop-2-ynyloxy]-3-methoxyphenyl}ethyl)-2-ethanesulfonylamino-3-methylbutyramide or 5-chloro-7-(4-methylpiperidin-1-yl)-6-(2,4,6-trifluorophenyl)-[1,2,4]triazolo[1,5-a]pyrimidine
   in synergistically effective amounts, by spraying or dusting the seeds, the plants or the soils before or after sowing of the plants or before or after emergence of the plants, no polyoxyalkylene alkyl ethers being used as adjuvants.

Moreover, the invention relates to novel synergistic mixtures of ethaboxam with active compounds from group b1) and also to compositions comprising these mixtures, and to the use of the compound I with active compounds from group b1) to prepare such mixtures.

Ethaboxam of the formula I, referred to above as component a), N-(cyano-2-thienylmethyl)-4-ethyl-2-(ethylamino)-5-thiazolecarboxamide, the preparation thereof and activity thereof against harmful fungi are known from the literature (EP-A 639 574).

The active compounds mentioned above as component b), their preparation and their action against harmful fungi are likewise generally known (cf. also: http://www.hclrss.demon.co.uk/index.html):

mancozeb, manganese ethylenebis(dithiocarbamate) zinc complex (U.S. Pat. No. 3,379,610);

maneb, manganese ethylenebis(dithiocarbamate) (U.S. Pat. No. 2,504,404);

metam, methyidithiocarbamic acid (U.S. Pat. No. 2,791,605);

metiram, zinc ammoniate ethylenebis(dithiocarbamate) (U.S. Pat. No. 3,248,400);

kresoxim-methyl, methyl (E)-methbxyimino[α-(otolyloxy)-o-tolyl]acetate (EP-A 253 213);

pyraclostrobin, methyl N-{2-[1-(4-chlorophenyl)-1H-pyrazol-3-yloxymethyl]phenyl}(N-methoxy)carbamate (WO-A 96/01256);

mefenoxam, methyl N-(methoxyacetyl)-N-(2,6-xylyl)-D-alaninate (WO 96/01559);

dimethomorph, 3-(4-chlorophenyl)-3-(3,4-dimethoxyphenyl)-1-morpholin-4-ylpropenone (EP-A 120 321);

flumorph, 3-(4-fluorophenyl)-3-(3,4-dimethoxyphenyl)-1-morpholin-4-ylpropenone (EP-A 860 438);

dithianon, 5,10-dioxo-5,10-dihydronaphtho[2,3-b][1,4]dithiin-2,3-dicarbonitrile (GB 857 383);

famoxadone, (RS)-3-anilino-5-methyl-5-(4-phenoxyphenyl)-1,3-oxazolidine-2,4-dione;

fenamidon, (S)-1-anilino-4-methyl-2-methylthio-4-phenylimidazolin-5-one;

chlorothalonil, 2,4,5,6-tetrachloroisophthalonitrile (U.S. Pat. No. 3,290,353);

fluazinam, 3-chloro-N-[3-chloro-2,6-dinitro-4-(trifluoromethyl)phenyl]-5-(trifluoromethyl)-2-pyridinamine (The Pesticide Manual, publ. The British Crop Protection Council, 10th ed. (1995), p. 474);

zoxamide, (RS)-3,5-dichloro-N-(3-chloro-1-ethyl-1-methyl-2-oxopropyl)-p-toluamide (CAS-No. 156052-68-5);

N-(2-{4-[3-(4-chlorophenyl)prop-2-ynyloxy]-3-methoxyphenyl}ethyl)-2-methane/ethanesulfonylamino-3-methylbutyramide (WO 99/07674); and 5-chloro-7-(4-methylpiperidin-1-yl)-6-(2,4,6-trifluorophenyl)-[1,2,4]triazolo[1,5-a]pyrimidine (WO 98/46607).

WO 01/84930 discloses formulations of ethaboxam which comprise polyoxyalkylene alkyl ethers and which, in addition to ethaboxam, may comprise a further active compound from group b). The use of the polyoxyalkylene alkyl ethers described results in an increase of the fungicidal effectiveness of ethaboxam.

Mixtures of ethaboxam with one of the following active compounds II from the group comprising:
b) maneb, metam, metiram, captan, strobilurin derivatives such as kresoxim-methyl or pyraclostrobin, flumorph, zoxamide, N-(2-{4-[3-(4-chlorophenyl)prop-2-ynyloxy]-3-methoxyphenyl}ethyl)-2-methanesulfonylamino-3-methylbutyramide, N-(2-{4-[3-(4-chlorophenyl)prop-2-ynyloxy]-3-methoxyphenyl}ethyl)-2-ethanesulfonylamino-3-methylbutyramide or 5-chloro-7-(4-methylpiperidin-1-yl)-6-(2,4,6-trifluorophenyl)-[1,2,4]triazolo[1,5-a]pyrimidine (formula II-1)

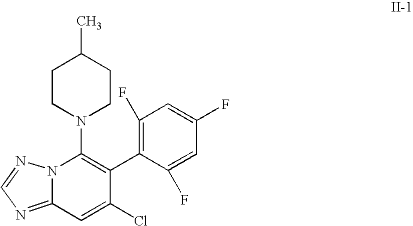

are novel.

With a view to minimizing the application rates of pesticides, it was an object of the present invention to increase the fungicidal effectiveness of ethaboxam independently of the use of certain formulation auxiliaries.

We have found that this is achieved by the method defined at the outset and the novel mixtures. Moreover, we have found that simultaneous, that is joint or separate, application of ethaboxam and at least one active compound from group b) or successive application of ethaboxam and at least one active compound from group b) allows better control of phytopathogenic harmful fungi than the individual compounds (synergistic mixtures). By applying ethaboxam simultaneously, that is jointly or separately, with at least one active compound from group b), the fungicidal effectiveness is increased in a superadditive manner.

The mixtures of ethaboxam and at least one active compound from group b), or the simultaneous, that is joint or separate, application of ethaboxam and at least one active compound from group b) are/is highly effective against a wide range of phytopathogenic fungi, in particular from the classes of the Ascomycetes, Deuteromycetes, Oomycetes and Basidiomycetes. They can be used in crop protection as foliar fungicides, as fungicides for seed dressing and as soil-acting fungicides.

They are particularly important for controlling a multitude of fungi on various cultivated plants, such as bananas, cotton, vegetable species (for example cucumbers, beans and cucurbits), barley, grass, oats, coffee, potatoes, corn, fruit species, rice, rye, soya, tomatoes, grapevines, wheat, ornamental plants, sugar cane and also on a large number of seeds.

They are advantageously suitable for the control of the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria species on wheat, Botrytis cinerea on strawberries, vegetables, ornamental plants and grapevines, Mycosphaerella species on bananas, peanuts and cereals, Pseudocercosporella herpotrichoides on wheat and barley, Pyricularia oryzae on rice, Phakopsora species on soybean, Phytophthora infestans on potatoes and tomatoes, Pseudoperonospora species on cucurbits and hops, Plasmopara viticola on grapevines, Alternaria species on fruit and vegetables and also Fusarium and Verticillium species.

They are particularly suitable for controlling harmful fungi from the class of the Oomycetes.

The combinations of ethaboxam and at least one active compound from group b) are furthermore suitable for controlling harmful fungi such as Paecilomyces variotii in the protection of materials (for example wood, paper, paint dispersions, fibers or fabrics) and in the protection of stored products.

Ethaboxam and active compounds from group b) can be applied simultaneously, that is jointly or separately, or in succession, the sequence, in the case of separate application, generally not having any effect on the result of the control measures.

Preferred in the method according to the invention are the combinations of ethaboxam with one of the compounds dithianon and dimethomorph.

A particularly preferred embodiment of the mixtures according to the invention relates to the combination of ethaboxam and strobilurins such as kresoxim-methyl or, in particular, pyraclostrobin.

A further preferred embodiment of the mixtures according to the invention relates to the combination of ethaboxam and 5-chloro-7-(4-methylpiperidin-1-yl)-6-(2,4,6-trifluorophenyl)-[1,2,4]triazolo[1,5-a]pyrimidine (formula II-1).

A further preferred embodiment of the mixtures according to the invention relates to the combination of ethaboxam and zoxamide.

When preparing the mixtures, it is preferred to employ the pure active compounds I and II, to which further active compounds III against harmful or other pests such as insects, arachnids or nematodes, or else herbicidal or growth-regulating active compounds or fertilizers may be added as further active components according to need.

Further suitable active compounds III in the above sense are in particular fungicides selected from the following group c):
acylalanines, such as benalaxyl, metalaxyl, ofurace or oxadixyl,
amine derivatives, such as aldimorph, dodine, dodemorph, fenpropimorph, fenpropidin, guazatine, iminoctadine, spiroxamine or tridemorph,
anilinopyrimidines, such as pyrimethanil, mepanipyrim or cyprodinyl,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole or triticonazole,
dicarboximides, such as iprodione, myclozolin or vinclozolin,
dithiocarbamates, such as ferbam, nabam, maneb, mancozeb, metam, metiram, propineb, polycarbamate, thiram, ziram or zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, picobenzamid, probenazole, pyrifenox, pyroquilon, quinoxyfen, silthiofam, thiabendazole, thifluzamide, thiophanate-methyl, tiadinil, tricyclazole or triforine,
copper fungicides, such as Bordeaux mixture, copper acetate, copper oxychloride or basic copper sulfate,
nitrophenyl derivatives, such as binapacryl, dinocap, dinobuton or nitrophthal-isopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, diclomezine, diclocymet, diethofencarb, edifenphos, fenhexamid, fentin acetate, fenoxanil, ferimzone, fluazinam, fosetyl, fosetyl-aluminum, iprovalicarb, hexachlorobenzene, metrafenone, pencycuron, propamocarb, phosphorous acid, phthalide, tolclofos-methyl, quintozene or zoxamide,
strobilurins, such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet or tolylfluanid,
cinnamides and analogous compounds, such as dimethomorph, flumetover or flumorph.

What is usually used are mixtures of ethaboxam with an active compound II from group b). Mixtures of ethaboxam with two active compounds II and III have a particularly strong fungicidal action. Suitable active compounds II are preferably those mentioned in group b), suitable further active compounds III are, in addition to the active compounds of group b), in particular phosphorous acid H₃PO₃, its alkali metall or alkaline earth metall salts or derivatives which release them, preferably ethyl phosphonate (common name: fosetyl) and ethyl phosphonate aluminum (common name: fosetyl-Al), or copper fungicides, such as Bordeaux mixture, copper acetate, copper oxychloride or basic copper sulfate.

A particularly preferred embodiment of the mixtures according to the invention relates to the combination of ethaboxam and fluazinam with a further active compound III.

A further particularly preferred embodiment of the mixtures according to the invention relates to the combination of ethaboxam and pyraclostrobin with a further active compound III.

A further particularly preferred embodiment of the mixtures according to the invention relates to the combination of ethaboxam and dithianon with a further active compound III.

A further particularly preferred embodiment of the mixtures according to the invention relates to the combination of ethaboxam and dimethomorph with a further active compound III.

A further particularly preferred embodiment of the mixtures according to the invention relates to the combination of ethaboxam with the compound of the formula II-1 and an active compound III from group c).

Ethaboxam and the active compound II are usually applied in a weight ratio of from 100:1 to 1:100, preferably from 20:1 to 1:50, in particular from 10:1 to 1:20.

The combination of ethaboxam with the compound of the formula II-1 is preferably present in a weight ratio of from 20:1 to 1:20, in particular from 10:1 to 1:10.

Further active compounds III are, if desired, added to ethaboxam preferably in a ratio of from 20:1 to 1:20. Advantageously, phosphorous acid and copper fungicides may also be added in significantly higher amounts. In ternary mixtures, the active compounds I:II:III are preferably present in ratios of from 100:1:2000 to 100:1:5 to 1:100:0.05 to 1:100:20.

Depending on the type of compound and the desired effect, the application rates of the mixtures according to the invention are from 5 g/ha to 2000 g/ha, preferably from 50 to 1750 g/ha, in particular from 50 to 1500 g/ha.

Correspondingly, the application rates for ethaboxam are generally from 1 to 750 g/ha, preferably from 10 to 500 g/ha, in particular from 20 to 250 g/ha.

Correspondingly, the application rates for an active compound II, depending on its type, are generally from 1 to 2000 g/ha, preferably from 10 to 1500 g/ha, in particular from 40 to 1200 g/ha. For the compound of the formula II-1, the application rates are usually from 5 g/ha to 1000 g/ha, preferably from 50 to 900 g/ha, in particular from 40 to 750 g/ha.

In the treatment of seed, application rates of mixture are generally from 1 to 1000 g/100 kg of seed, preferably from 1 to 750 g/100 kg, in particular from 5 to 500 g/100 kg.

The method for controlling harmful fungi is carried out by the separate or joint application of ethaboxam and at least one active compound from group b) or of the mixtures of ethaboxam and at least one active compound from group b) by spraying or dusting the seeds, the plants or the soil before or after sowing of the plants or before or after emergence of the plants, where in the case of active compounds II which do not belong to group b1, no polyoxyalkylene alkyl ethers are used as adjuvants.

The mixtures according to the invention, or ethaboxam and the active compound from group b1), can be converted into the customary formulations, for example solutions, emulsions, suspensions, dusts, powders, pastes and granules. Suitable adjuvants for formulations comprising the mixtures according to the invention include polyoxyalkylene alkyl ethers. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Formulations for treating seed may additionally comprise binders and/or gelling agents and, if appropriate, colorants.

Binders may be added to increase the adherence of the active compounds on the seed after treatment. Suitable binders are, for example, EO/PO block copolymer surfactants, and also polyvinyl alcohols, polyvinylpyrrolidones, polyacrylates, polymethacrylates, polybutenes, polyisobutylenes, polystyrenes, polyethyleneamines, polyethyleneamides, polyethyleneimines (Lupasol®, Polymin®), polyethers, polyurethanes, polyvinyl acetates, tylose and copolymers of these polymers. A suitable gelling agent is, for example, carrageen (Satiagel®).

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The active compound concentrations in the ready-to-use preparations can be varied within relatively wide ranges. In general, they are between 0.0001 and 10%, preferably between 0.01 and 1%.

With good results, the active compounds can also be applied by the ultra low volume (ULV) method, it being possible to apply formulations comprising more than 95% by weight of active compound or even the active compound without additives.

For the treatment of seed, the formulations in question give, after two-to-tenfold dilution, active compound concentrations of from 0.01 to 60% by weight, preferably from 0.1 to 40% by weight, in the ready-to-use preparations.

The following are examples of formulations: 1. Products for dilution with water

A) Water-Soluble Concentrates (SL, LS)

10 parts by weight of the active compounds are dissolved in 90 parts by weight of water or in a water-soluble solvent. As an alternative, wetters or other auxiliaries are added. The active compound dissolves upon dilution with water. In this way, a formulation having a content of 10% by weight of active compound is obtained.

B) Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight.

C) Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D) Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The formulation has an active compound content of 25% by weight.

E) Suspensions (SC, OD, FS)

In an agitated ball mill, 20 parts by weight of the active compounds are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of the active compounds are ground finely with addition of 50 parts by weight of dispersants and wetters and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP, SS, WS)

75 parts by weight of the active compounds are ground in a rotor-stator mill with addition of 25 parts by weight of dispersants, wetters and silica gel. Dilution with water gives a stable dispersion or solution of the active compound. The active compound content is 75% by weight.

H) Gel Formulations

In a ball mill, 20 parts by weight of the active compounds, 10 parts by weight of dispersant, 1 part by weight of gelling agent and 70 parts by weight of water or an organic solvent are ground to give a fine suspension. On dilution with water, a stable suspension having an active compound content of 20% by weight is obtained.

2. Products to be Applied Undiluted

I) Dustable powders (DP, DS)

5 parts by weight of the active compounds are ground finely and mixed intimately with 95% of finely divided kaolin. This gives a dustable product having an active compound content of 5% by weight.

J) Granules (GR, FG, GG, MG)

0.5 part by weight of the active compounds is ground finely and associated with 99.5% carriers. Current methods are extrusion, spray-drying or the fluidized bed. This gives granules to be applied undiluted having an active compound content of 0.5% by weight.

K) ULV Solutions (UL)

10 parts by weight of the active compounds are dissolved in 90 parts by weight of an organic solvent, for example xylene. This gives a product to be applied undiluted having an active compound content of 10% by weight.

For seed treatment, use is usually made of water-soluble concentrates (LS), suspensions (FS), dustable powders (DS), water-dispersible and water-soluble powders (WS, SS), emulsions (ES), emulsifiable concentrates (EC) and gel formulations (GF). These formulations can be applied to the seed in undiluted form or, preferably, diluted. Application can be carried out prior to sowing.

Preference is given to using FS formulations for seed treatment. Usually, such formulations comprise from 1 to 800 g of active compound/l, from 1 to 200 g of surfactants/l, from 0 to 200 g of antifreeze agents/l, from 0 to 400 g of binder/l, from 0 to 200 g of colorants/l and solvents, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents may be admixed with the compositions according to the invention in a weight ratio of from 1:100 to 100:1, preferably from 1:10 to 10:1.

Suitable adjuvants in this sense are in particular: organically modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctylsulfosuccinate, for example Leophen RA®.

The compounds I and II or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal effect of the compound and the mixtures is demonstrated by the following tests:

The active compounds were prepared jointly or separately as a stock solution with 25 mg of active compound which was made up to 10 ml using a mixture of acetone and/or DMSO and the emulsifier Uniperol® EL (wetting agent having emulsifying and dispersing action based on ethoxylated alkylphenols) in a volume ratio of solvent/emulsifier of 99 to 1. The mixture was then made up with water to 100 ml. This stock solution was diluted with the solvent/emulsifier/water mixture described to the concentration of active compounds stated below.

The active compounds pyraclostrobin, famoxadone, fluazinam and zoxamide were used as commercially available formulations.

The visually determined percentages of infected leaf areas were converted into efficacies in % of the untreated control:

The efficacy (E) is calculated as follows using Abbot's formula:

E=(1−α/β)·100

α corresponds to the fungicidal infection of the treated plants in % and

β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of mixtures of active compounds were determined using Colby's formula (Colby, S. R. “Calculating synergistic and antagonistic responses of herbicide combinations”, Weeds, 15, 20-22, 1967) and compared with the observed efficacies.

Colby's formula:

E=x+y−x·y/100
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

I. Greenhouse Tests

### USE EXAMPLE 1

Effectiveness Against Peronospora of Grapevines Caused by Plasmopara viticola at 7 days of Protective Application

Leaves of potted vines were sprayed to runoff point with an aqueous suspension having the concentration of active compound given below. To be able to assess the persistency of the substances, the plants were, after the spray coating had dried on, placed in a greenhouse for 7 days. Only then were the leaves inoculated with an aqueous zoospore suspension of Plasmopara viticola. The grapevines were then initially placed in a water-vapor-saturated chamber at 24° C. for 48 hours and then in a greenhouse at temperatures between 20 and 30° C. for 5 days. After this period of time the plants were, to promote sporangiophore eruption, again placed in a humid chamber for 16 hours. The extent of the development of the infection on the undersides of the leaves was then determined visually.

| | | | | | Calculated |
|---|---|---|---|---|---|
| | | | | | effect |
| | | Conc. | | Observed | according to |
| No. | Active compound | [ppm] | Ratio | effect (%) | Colby (%) |
| 1 | — (control) | — | | 0 (90% | |
| | | | | infection) | |
| 2 | ethaboxam I | 16 | | 44 | |
| | | 4 | | 22 | |
| | | 1 | | 0 | |
| 3 | II-1 | 4 | | 22 | |
| | | 0.25 | | 0 | |
| 4 | dimethomorph | 4 | | 0 | |
| | II-2 | | | | |
| 5 | cymoxanil II-3 | 4 | | 0 | |
| 6 | fluazinam II-4 | 63 | | 22 | |
| 7 | I + II-1 | 1 + 0.25 | 4:1 | 44 | 0 |
| 8 | I + II-1 | 1 + 4 | 1:4 | 56 | 0 |
| 9 | I + II-2 | 16 + 4 | 4:1 | 94 | 44 |
| 10 | I + II-2 | 4 + 4 | 1:1 | 78 | 22 |
| 11 | I + II-3 | 16 + 4 | 4:1 | 99 | 44 |
| 12 | I + II-4 | 16 + 63 | 1:4 | 67 | 57 |

### USE EXAMPLE 2

Effectiveness Against Peronospora of Grapevines Caused by Plasmopara viticola, Protective Application

Leaves of potted vines were sprayed to runoff point with an aqueous suspension having the concentration of active compound given below. The plants were placed in a greenhouse for 3 days so that the spray coating could dry. The leaves were then inoculated with an aqueous zoospore suspension of Plasmopara viticola. The grapevines were then initially placed in a water-vapor-saturated chamber at 24° C. for 48 hours and then in a greenhouse at temperatures between 20 and 30° C. for 5 days. After this period of time the plants were, to promote sporangiophore eruption, again placed in a humid chamber for 16 hours. The extent of the development of the infection on the undersides of the leaves was then determined visually.

| | | | | | Calculated effect |
|---|---|---|---|---|---|
| | | Conc. | | Observed | according to |
| No. | Active compound | [ppm] | Ratio | effect (%) | Colby (%) |
| 13 | — (control) | — | | 0 (77% | |
| | | | | infection) | |
| 14 | ethaboxam I | 1 | | 61 | |
| 15 | maneb II-5 | 1 | | 0 | |
| 16 | I + II-5 | 1 + 1 | 1:1 | 81 | 61 |

### USE EXAMPLE 3

Activity Against Late Blight on Tomatoes Caused by Phytophthora infestans, Protective Application

Leaves of potted tomato plants were sprayed to runoff point in the concentration of active compound given below. To allow the active compound coat to dry on, the plants were placed in a greenhouse at about 20° C. for 3 days, and the leaves were then inoculated with an aqueous sporangia suspension of Phytophthora infestans. The plants were then placed in a water-vapor-saturated chamber at temperatures between 18 and 20° C. After 6 days, the blight on the untreated but infected control plants had developed to such an extent that the infection could be determined visually in %.

| | | | | | Calculated effect |
|---|---|---|---|---|---|
| | | Conc. | | Observed | according to |
| No. | Active compound | [ppm] | Ratio | effect (%) | Colby (%) |
| 17 | — (control) | — | | 0 (90% | |
| | | | | infection) | |
| 18 | ethaboxam I | 16 | | 33 | |
| 19 | dimethomorph | 16 | | 22 | |
| | II-2 | 4 | | 0 | |
| 20 | I + II-2 | 16 + 4 | 4:1 | 56 | 33 |
| 21 | I + II-2 | 16 + 16 | 1:1 | 67 | 48 |

II. Microtiter Tests

For the following use examples, the active compounds were formulated separately as a stock solution having a concentration of 10 000 ppm in DMSO.

The active compounds epoxiconazole, famoxadone, fluazinam and zoxamide were used as commercially available formulations and pre-diluted with water to give a 10 000 ppm stock solution.

The stock solutions were mixed according to the ratio in question, pipetted onto a microtiter plate (MTP) and diluted to the stated active compound concentration using an aqueous malt-based fungus nutrient medium. An aqueous spore suspension of the pathogen in question was then added. The plates were placed in a water-vapor-saturated chamber at temperatures of 18° C. The MTPs were measured on day 7 after the inoculation at 405 nm using an absorption photometer.

The measured parameters were compared to the growth of the active compound-free control variant and the fungus- and active compound-free zero value to determine the relative growth in % of the pathogens in the individual active compounds.

### USE EXAMPLE 4

Activity Against the Causative Organism of Gray Mold Botrytis cinerea in the Microtiter Test

| | | | | | Calculated |
|---|---|---|---|---|---|
| | | | | | effect |
| | | Conc. | | Observed | according to |
| No. | Active compound | [ppm] | Ratio | effect (%) | Colby (%) |
| 22 | ethaboxam I | 63 | | 11 | |
| | | 32 | | 0 | |
| | | 4 | | 0 | |
| | | 2 | | 0 | |
| | | 1 | | 0 | |
| 23 | dimethomorph II-2 | 63 | | 9 | |
| 24 | pyraclostrobin II-6 | 0.5 | | 22 | |
| 25 | zoxamide II-7 | 32 | | 23 | |
| 26 | flumorph II-8 | 63 | | 16 | |
| 27 | mancozeb II-9 | 4 | | 30 | |
| 28 | folpet II-10 | 1 | | 38 | |
| 29 | I + II-2 | 63 + 63 | 1:1 | 60 | 19 |
| 30 | I + II-6 | 2 + 0.5 | 4:1 | 48 | 22 |
| 31 | I + II-7 | 32 + 32 | 1:1 | 56 | 23 |
| 32 | I + II-8 | 63 + 63 | 1:1 | 47 | 25 |
| 33 | I + II-9 | 4 + 4 | 1:1 | 79 | 30 |
| 34 | I + II-10 | 1 + 1 | 1:1 | 65 | 38 |

### USE EXAMPLE 5

Activity Against the Causative Organism of Rice Blast Pyricularia oryzae in the Microtiter Test

| | | | | | Calculated |
|---|---|---|---|---|---|
| | | | | | effect |
| | Active | Conc. | | Observed | according to |
| No. | compound | [ppm] | Ratio | effect (%) | Colby (%) |
| 48 | ethaboxam I | 16 | | 0 | |
| | | 4 | | 0 | |
| | | 0.125 | | 0 | |
| 49 | mancozeb II-9 | 1 | | 29 | |
| 50 | folpet II-10 | 4 | | 54 | |
| 51 | metiram II-14 | 4 | | 19 | |
| 52 | dithianon II-15 | 0.125 | | 35 | |
| 53 | I + II-9 | 4 + 1 | 4:1 | 54 | 29 |
| 54 | I + II-10 | 16 + 4 | 4:1 | 100 | 54 |
| 55 | I + II-14 | 16 + 4 | 4:1 | 91 | 19 |
| 56 | I + II-15 | 0.125 + 0.125 | 1:1 | 60 | 35 |

The test results show that, by virtue of strong synergism, the effectiveness of the mixtures according to the invention is considerably higher than had been predicted using Colby's formula.

| | | | | | Calculated |
|---|---|---|---|---|---|
| | | | | | effect |
| | Active | Conc. | | Observed | according to |
| No. | compound | [ppm] | Ratio | effect (%) | Colby (%) |
| 35 | ethaboxam I | 63 | | 56 | |
| | | 16 | | 41 | |
| | | 8 | | 18 | |
| | | 0.25 | | 0 | |
| | | 0.125 | | 0 | |
| 36 | dimethomorph | 4 | | 6 | |
| | II-2 | | | | |
| 37 | flumorph II-8 | 16 | | 11 | |
| 38 | folpet II-10 | 1 | | 20 | |
| 39 | famoxadone | 0.5 | | 64 | |
| | II-11 | | | | |
| 40 | fosethyl-Al | 63 | | 8 | |
| | II-12 | | | | |
| 41 | zoxamide II-13 | 8 | | 10 | |
| 42 | I + II-2 | 16 + 4 | 4:1 | 60 | 44 |
| 43 | I + II-8 | 16 + 16 | 1:1 | 67 | 47 |
| 44 | I + II-10 | 0.25 + 1 | 1:4 | 44 | 20 |
| 45 | I + II-11 | 0.125 + 0.5 | 1:4 | 76 | 64 |
| 46 | I + II-12 | 63 + 63 | 1:1 | 78 | 59 |
| 47 | I + II-13 | 8 + 8 | 1:1 | 90 | 26 |

### USE EXAMPLE 6

Activity Against the Causative Organism of Septoria Speckled Leaf Blotch Septoria tritici in the Microtiter Test

1-14. (canceled)

15. A method for enhancing the fungicidal effectiveness of
a) ethaboxam of the formula I, 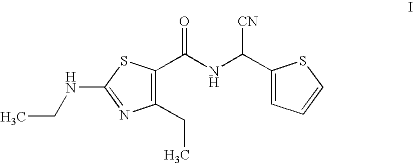
which comprises the active compound I simultaneously, separately or together, with at least one active compound II from the group consisting of:
b) dithiocarbamates, selected from the group consisting of maneb, mancozeb, metam and metiram,
sulfenic acid derivatives, selected from the group consisting of captan and folpet,
strobilurin derivatives, selected from the group consisting of kresoxim-methyl and pyraclostrobin,
cinnamides and analogs, selected from the group consisting of dimethomorph and flumorph, or
dithianon, famoxadone, cymoxanil, fluazinam, zoxamide or chlorothalonil being applied in synergistically effective amounts, by spraying or dusting the seeds, the plants or the soils before or after sowing of the plants or before or after emergence of the plants, no polyoxyalkylene alkyl ethers being used as adjuvants.

16. The method according to claim 15, wherein the active compound II is selected from the group consisting of metiram, dimethomorph and dithianon.

17. A fungicidal mixture, comprising, as active components,
a) ethaboxam of the formula I, 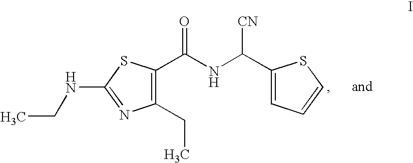
b) as active compound II a compound comprising maneb, metam, metiram, captan, kresoxim-methyl, pyraclostrobin, flumorph, or zoxamide in synergistically effective amounts.

18. The fungicidal mixture according to claim 17, comprising, as active compound II, kresoxim-methyl or pyraclostrobin.

19. The fungicidal mixture according to claim 17, comprising the active compounds I and II in a weight ratio of from 100:1 to 1:100.

20. A ternary fungicidal mixture, comprising, as active components,
a) ethaboxam of the formula I, 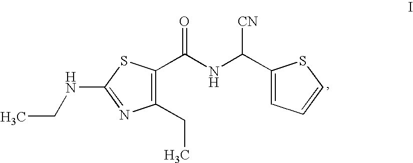
b) an active compound II selected from the group consisting of:
dithiocarbamates, selected from the group consisting of maneb, mancozeb, metam and metiram,
sulfenic acid derivatives, selected from the group consisting of captan and folpet,
strobilurin derivatives, selected from the group consisting of kresoxim-methyl and pyraclostrobin,
cinnamides and analogs, selected from the group consisting of dimethomorph and flumorph, or
dithianon, famoxadone, cymoxanil, fluazinam, zoxamide or chlorothalonil, and
c) a further active compound III of group b) or phosphorous acid H₃PO₃, its alkali or alkaline earth metal salts or derivatives which release them, or copper fungicides; in synergistically effective amounts.

21. The ternary fungicidal mixture according to claim 20, comprising, as active compound II, pyraclostrobin, dithianon or dimethomorph.

22. The ternary fungicidal mixture according to claim 20, comprising, as active compound III, dimethomorph, fluazinam or pyraclostrobin.

23. The ternary fungicidal mixture according to claim 20, comprising, as active compound III, phosphorous acid, fosetyl-Al or a copper fungicide.

24. The ternary fungicidal mixture according to claim 21, comprising, as active compound III, phosphorous acid, fosetyl-Al or a copper fungicide.

25. The ternary fungicidal mixture according to claim 20, comprising the active compounds I:II:III in weight ratios of 100:1:2000 to 100:1:5 to 1:100:0.05 to 1:100:20.

26. A fungicidal composition, comprising a solid or liquid carrier and a mixture according to claim 17.

27. A fungicidal composition, comprising a solid or liquid carrier and a mixture according to claim 20.

28. A method for controlling harmful fungi, wherein the fungi, their habitat or the plants, the soil or seed to be protected against fungal attack is/are treated with an effective amount of a mixture according to claim 17.

29. A method for controlling harmful fungi, wherein the fungi, their habitat or the plants, the soil or seed to be protected against fungal attack is/are treated with an effective amount of a mixture according to claim 20.

30. A method for controlling harmful fungi, wherein the fungi, their habitat or the plants, the soil or seed to be protected against fungal attack is/are treated with an effective amount of a fungicidal composition comprising a solid or liquid carrier and a mixture according to claim 17.

31. A method for controlling harmful fungi, wherein the fungi, their habitat or the plants, the soil or seed to be protected against fungal attack is/are treated with an effective amount of a fungicidal composition comprising a solid or liquid carrier and a mixture according to claim 20.

32. The method according to claim 28, wherein ethaboxam and an active compound II comprising maneb, metam, metiram, captan, kresoxim-methyl, pyraclostrobin, flumorph, or zoxamide are applied simultaneously, together or separately, or in succession.

33. The method according to claim 29, wherein ethaboxam and an active compound II comprising maneb, metam, metiram, captan, kresoxim-methyl, pyraclostrobin, flumorph, or zoxamide are applied simultaneously, together or separately, or in succession.

34. Seed, comprising the mixture according to claim 17 in an amount of from 1 to 1000 g/100 kg.

35. Seed, comprising the mixture according to claim 20 in an amount of from 1 to 1000 g/100 kg.

36. A method of preparing a fungicidal composition comprising combining a solid or liquid carrier and a mixture comprising ethaboxam of the formula I, 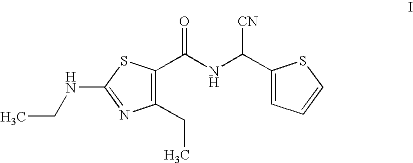
and an active compound comprising maneb, metam, metiram, captan, kresoxim-methyl, pyraclostrobin, flumorph, or zoxamide.

37. A process for preparing a composition according to claim 13 by extending ethaboxam and at least one active compound II comprising maneb, metam, metiram, captan, kresoxim-methyl, pyraclostrobin, flumorph, or zoxamide.
